(19) United States
(12) Patent Application Publication
(10) Pub. No.: US 2018/0147907 A1
(43) Pub. Date: May 31, 2018

(54) INVERTED SHOCK ABSORBER

(71) Applicant: Jui-Lin KAO, Keelung (TW)

(72) Inventor: Jui-Lin KAO, Keelung (TW)

(21) Appl. No.: 15/826,672

(22) Filed: Nov. 29, 2017

(30) Foreign Application Priority Data
Nov. 30, 2016 (TW) 105139341

(51) Int. Cl. B60G 15/06; F16F 13/14

(52) U.S. Cl. CPC B60G 15/066; B60G 2204/418; F16F 13/14

(57) ABSTRACT

A inverted type shock absorber, comprising: an outer cylinder; a damping cylinder including a cylinder body and a piston rod, wherein the cylinder body is coaxially sleeved within the outer cylinder; at least three bearings which are fixed at different upper-lower positions of an internal surface of the outer cylinder to support the external surface of the cylinder body such that the cylinder body is slidable against the outer cylinder along the expanding-compressing direction; and an rubber stabilizer which tightly surround the external surface of the cylinder body in such a manner that the rubber stabilizer is sandwiched between two of said at least three bearings such that the rubber stabilizer provides the cylinder body a stabilizing force which radially retains the cylinder body relative to the outer cylinder to stabilize the sliding between the outer cylinder and the cylinder body.

### TECHNICAL FIELD

The present invention relates to a shock absorber, and more particularly to an inverted type shock absorber.

### BACKGROUND

A shock absorber is configured to absorb impact force caused by bumps and potholes in the roads and is widely used in vehicles such as cars and motorcycles. Shock absorbers can be categorized into two types including an upright type shock absorber and an inverted type shock absorber, wherein the inverted type shock absorber is with a damping cylinder supported by two bearings fixed at an outer cylinder of the inverted type shock absorber. The inverted type shock absorber is favored by car enthusiasts due to its good shock resistance and stability.

However, after a long term usage, the inverted type shock absorber is with drawback that the bearings tend to have an uneven wear and damage caused by the damping cylinder, which widens the gap between the damping cylinder and the bearings.

The gap between the damping cylinder and the bearings will result in abnormal noises when the vehicle is driving and thus reduces the drive quality.

### SUMMARY

Accordingly, an objective of the present invention is to provide an inverted type shock absorber capable of preventing the bearings from the uneven wear and damage caused by the damping cylinder.

To solve the issues above, the present invention provides a inverted type shock absorber, comprising: an outer cylinder; a damping cylinder including a cylinder body and a piston rod, wherein the cylinder body is coaxially sleeved within the outer cylinder in an upper-lower direction where an external surface of the cylinder body is allocated to face forward an internal surface of the outer cylinder, and one end of the piston rod is fixed to a lower end of the outer cylinder, and the other end of the piston rod is inserted into an inner space of the cylinder body; at least three bearings which are disposed between the internal surface of the outer cylinder and the external surface of the cylinder body, and the bearings are fixed at different upper-lower positions of an internal surface of the outer cylinder in an expanding-compressing direction to support the external surface of the cylinder body such that the cylinder body is slidable with respect to the outer cylinder in the expanding-compressing direction; and an rubber stabilizer which is disposed between the internal surface of the outer cylinder and the external surface of the cylinder body, the rubber stabilizer being provided to tightly surround the external surface of the cylinder body in such a manner that the rubber stabilizer is sandwiched between two of said at least three bearings in the upper-lower direction such that the rubber stabilizer provides the cylinder body a stabilizing force which radially retains the cylinder body relative to the outer cylinder to stabilize the sliding between the outer cylinder and the cylinder body.

According to an embodiment of the present invention, the two bearings between which the elastic stabilizer is sandwiched are disposed close to an upper end of the outer cylinder.

According to an embodiment of the present invention, the two bearings between which the elastic stabilizer is sandwiched are disposed at a midpoint between an upper end of the outer cylinder and a lower end of the cylinder body when the inverted type shock absorber is in a status of being uncompressed.

According to an embodiment of the present invention, the two bearings between which the elastic stabilizer is sandwiched are disposed close to a lower end of the cylinder body when the inverted type shock absorber is in a status of being uncompressed.

According to an embodiment of the present invention, the rubber stabilizer is an O-ring.

According to an embodiment of the present invention, the rubber stabilizer is a X-ring.

According to an embodiment of the present invention, a width of the two bearings between which the elastic stabilizer is sandwiched is equal.

According to an embodiment of the present invention, a width of the two bearings between which the elastic stabilizer is sandwiched is unequal.

According to an embodiment of the present invention, the bearings are self-lubricating bearings.

By the technical means adopted by the inverted type shock absorber of the present invention, the rubber stabilizer provides a stabilizing force to radially retaining a position of the cylinder body. Therefore, when an uneven force is applied to the bearings by the damping cylinder, the stabilizing force which is opposite to the uneven force give rise to compensate the uneven force so as to avoid the occurrence of uneven wear and damage to the bearing resulting from the damping cylinder. Therefore the lifespan of the inverted type shock absorber can be prolonged.

In addition, as compared to the prior inverted type shock absorber, the inverted type shock absorber of the present invention is with at least one additional bearing being fixed allocated to provide an auxiliary support on the damping cylinder such that a better stabilizing effect to the damping cylinder is achieved.

### BRIEF DESCRIPTION OF THE DRAWINGS

FIG. 1 is a cross-sectional side view of an inverted type shock absorber according to a first embodiment of the present invention;

FIG. 2 is a partial cross-sectional side view showing vicinity of a rubber stabilizer of the inverted type shock absorber according to the first embodiment of the present invention;

FIG. 3 is a partial cross-sectional side view showing vicinity of a rubber stabilizer of an inverted type shock absorber according to a second embodiment of the present invention.

### DETAILED DESCRIPTION OF THE PREFERRED EMBODIMENTS

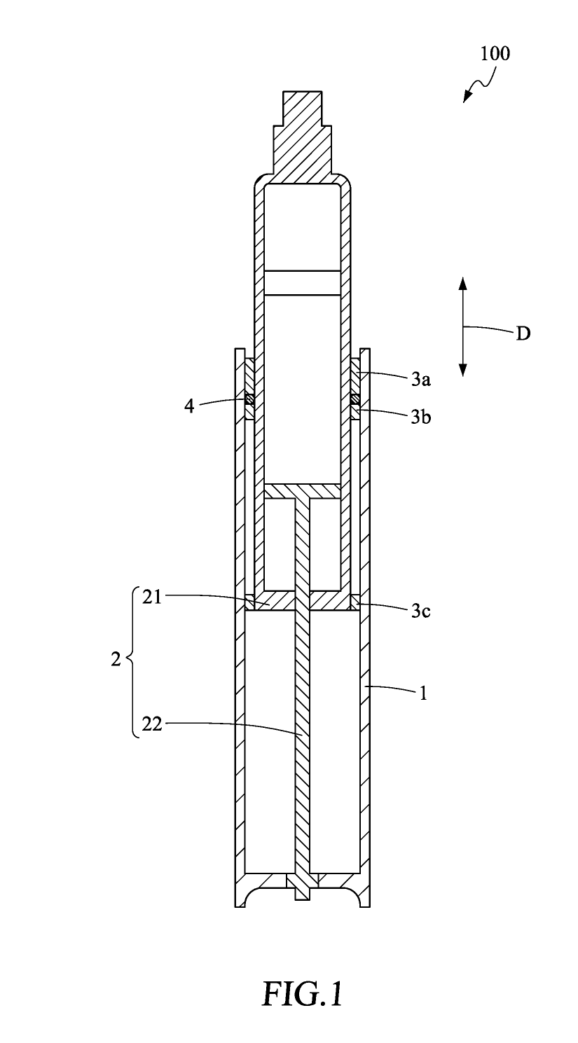

The preferred embodiments of the present invention are described in detail below with reference to FIG. 1 to FIG. 3. The description is used for explaining the embodiments of the present invention only, but not for limiting the scope of the present invention.

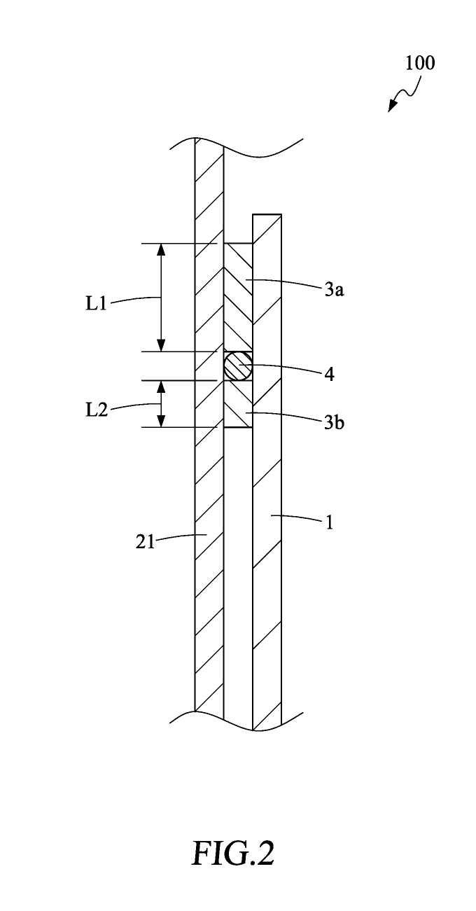

As shown in FIG. 1 and FIG. 2, an inverted type shock absorber 100 according to a first embodiment of the present invention comprises: an outer cylinder 1; a damping cylinder 2 including a cylinder body 21 and a piston rod 22, wherein the cylinder body 21 is coaxially sleeved within the outer cylinder 1 in an upper-lower direction where an external surface of the cylinder body 21 is allocated to face forward an internal surface of the outer cylinder 1, and one end of the piston rod 22 is fixed to a lower end of the outer cylinder 1, and the other end of the piston rod 22 is inserted into an inner space of the cylinder body 21; at least three bearings 3a, 3b and 3c which are disposed between the internal surface of the outer cylinder 1 and the external surface of the cylinder body 21, and the bearings 3a, 3b and 3c are fixed at different upper-lower positions of an internal surface of the outer cylinder 1 in an expanding-compressing direction D to support the external surface of the cylinder body 21 such that the cylinder body 21 is slidable with respect to the outer cylinder 1 in the expanding-compressing direction D; and an rubber stabilizer 4 which is disposed between the internal surface of the outer cylinder 1 and the external surface of the cylinder body 21, the rubber stabilizer 4 being provided to tightly surround the external surface of the cylinder body 21 in such a manner that the rubber stabilizer 4 is sandwiched between two 3a and 3b of said at least three bearings 3a, 3b and 3c in the upper-lower direction such that the rubber stabilizer 4 provides the cylinder body 21 a stabilizing force which radially retains the cylinder body 21 relative to the outer cylinder 1 to stabilize the sliding between the outer cylinder 1 and the cylinder body 21.

In detail, the inverted type shock absorber 100 is a monotube type shock absorber, which is generally used for shock absorbing of a car. The three bearings 3a, 3b and 3c disposed between the outer cylinder 1 and the cylinder body 21 are self-lubricating bearings which offer low friction without lubrication. In other embodiments, the bearings 3a, 3b and 3c may optionally be other types of axial sliding bearings. The rubber stabilizer 4 can be an O-ring, by which the stabilizing force provided to radially retain the cylinder body is applied toward the central axis of the outer cylinder 1 so as to keep the cylinder body 21 at the very center of the outer cylinder 1. In other embodiments, the rubber stabilizer 4 also can be other types of ring such as X-ring.

When an uneven force is applied from the cylinder body 21 to one side of the bearings 3a, 3b and 3c, the stabilizing force opposite to the uneven force to give rise to compensate for the uneven force can be provided by the rubber stabilizer 4 such that the uneven wear and damage of the bearings 3a, 3b and 3c caused by the damping cylinder 2 can be avoided. Therefore the lifespan of the inverted type shock absorber 100 can be prolonged.

In the inverted type shock absorber 100 according to the first embodiment of the present invention as shown in FIG. 2, the two bearings 3a, 3b between which the elastic stabilizer 4 is sandwiched are disposed close to an upper end of the outer cylinder 1. In other embodiment, the two bearings 3a, 3b between which the elastic stabilizer 4 is sandwiched can also be disposed close to a lower end of the cylinder body 21 or a midpoint between the upper end of the outer cylinder 1 and the lower end of the cylinder body 21 when the inverted type shock absorber is in a status of being uncompressed so as to provide the stabilizing force to different positions of the damping cylinder 2.

Specifically, a width L1 of the upper bearing 3a and a width L2 of the lower bearing 3b are unequal. Compared with the conventional inverted type shock absorber, the inverted type shock absorber in the embodiment provides an additional bearing 3b smaller in width at the inner surface of the outer cylinder 1 in such a manner to confine the position of the rubber stabilizer 4 without substantially affecting the original friction between the bearings 3a and 3c and the cylinder body 21. In other words, the width L2 of the bearing 3b is smaller than the width L1 of the bearing 3a. The bearing 3b assists the bearing 3a in supporting the cylinder body 21 to enhance the effect of stabilizing the cylinder body 21.

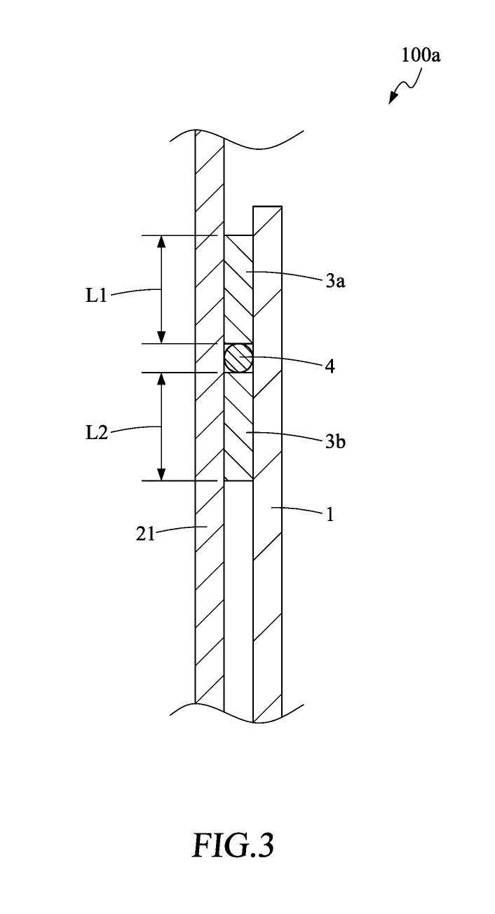

As shown in FIG. 3, the inverted type shock absorber 100a according to a second embodiment of the present invention is generally similar to the inverted type shock absorber 100 of the first embodiment. The difference is that the widths L1 and L2 of the two bearings 3a and 3b between which the elastic stabilizer 4 is sandwiched are equal. That is, the width L2 of the bearing 3b in the second embodiment is greater than that of the first embodiment. Accordingly, the bearings 3a and 3b in the second embodiment can be provided with a unified specification to lower the production cost. In addition, the bearing 3b in the second embodiment such that a greater stabilizing effect for the cylinder body 21 is achieved in comparison with that in the first embodiment.

The above description should be considered as only the discussion of the preferred embodiments of the present invention. A person having ordinary skill in the art may make various modifications to the present invention. However, those modifications still fall within the spirit of the present invention and the scope defined by the appended claims.

What is claimed is:

1. An inverted type shock absorber, comprising:
an outer cylinder;
a damping cylinder including a cylinder body and a piston rod, wherein the cylinder body is coaxially sleeved within the outer cylinder in an upper-lower direction where an external surface of the cylinder body is allocated to face forward an internal surface of the outer cylinder, and one end of the piston rod is fixed to a lower end of the outer cylinder, and the other end of the piston rod is inserted into an inner space of the cylinder body;
at least three bearings which are disposed between the internal surface of the outer cylinder and the external surface of the cylinder body, and the bearings are fixed at different upper-lower positions of an internal surface of the outer cylinder in an expanding-compressing direction to support the external surface of the cylinder body such that the cylinder body is slidable with respect to the outer cylinder in the expanding-compressing direction; and
an rubber stabilizer which is disposed between the internal surface of the outer cylinder and the external surface of the cylinder body, the rubber stabilizer being provided to tightly surround the external surface of the cylinder body in such a manner that the rubber stabilizer is sandwiched between two of said at least three bearings in the upper-lower direction such that the rubber stabilizer provides the cylinder body a stabilizing force which radially retains the cylinder body relative to the outer cylinder to stabilize the sliding between the outer cylinder and the cylinder body.

2. The inverted type shock absorber as claimed in claim 1, wherein the two bearings between which the elastic stabilizer is sandwiched are disposed at an upper end of the outer cylinder.

3. The inverted type shock absorber as claimed in claim 1, wherein the two bearings between which the elastic stabilizer is sandwiched are disposed at a midpoint between an upper end of the outer cylinder and a lower end of the cylinder body when the inverted type shock absorber is in a status of being uncompressed.

4. The inverted type shock absorber as claimed in claim 1, wherein the two bearings between which the elastic stabilizer is sandwiched are disposed close to a lower end of the cylinder body when the inverted type shock absorber is in a status of being uncompressed.

5. The inverted type shock absorber as claimed in claim 1, wherein the rubber stabilizer is an O-ring.

6. The inverted type shock absorber as claimed in claim 1, wherein the rubber stabilizer is an X-ring.

7. The inverted type shock absorber as claimed in claim 1, wherein a width of the two bearings between which the elastic stabilizer is sandwiched is equal.

8. The inverted type shock absorber as claimed in claim 1, wherein a width of the two bearings between which the elastic stabilizer is sandwiched is unequal.

9. The inverted type shock absorber as claimed in claim 1, wherein the bearings are self-lubricating bearings.
